(19) United States
(12) Patent Application Publication
(10) Pub. No.: US 2026/0188821 A1
(43) Pub. Date: Jul. 2, 2026

(54) Battery Belt

(71) Applicant: Deer Management Systems, LLC, Caledonia, MN (US)

(72) Inventors: Garrison Peel, Caledonia, MN (US); Jeffrey Peel, Decorah, IA (US); Mario Bonardi, Billings, MT (US); Orrin Bigelow, Pohoa, HI (US)

(21) Appl. No.: 19/429,324

(22) Filed: Dec. 22, 2025

Related U.S. Application Data
(60) Provisional application No. 63/739,167, filed on Dec. 27, 2024.

(51) Int. Cl. H01M 50/256; H01M 10/42; H01M 10/46

(52) U.S. Cl. CPC H01M 50/256; H01M 10/425; H01M 10/46

(57) ABSTRACT

A battery belt may include one or more battery modules and a belt. Each battery module may include a battery module housing having one or more battery belt loops and one or more battery cells in the battery module housing. The belt may include a belt strap and a belt buckle. Each belt loop may be sized to permit threading of the belt strap therethrough.

### CROSS-REFERENCE TO RELATED APPLICATIONS

The present application claims benefit of and priority to U.S. Provisional Application No. 63/739,167, filed Dec. 27, 2024, the contents of which is hereby incorporated herein by reference in its entirety.

### TECHNICAL FIELD

Aspects of the present disclosure relate to external battery packs and systems for powering cameras and other equipment.

### BACKGROUND

Trail cameras and surveillance cameras may be mounted to trees, poles, or other structures to capture still images and/or video clips of wildlife, people, etc. within the field of view of the camera. Once deployed, the cameras are often left in the field for extended periods of time (e.g., weeks, months, or even years). Due to the remote nature of such deployments, external battery packs may be deployed alongside the cameras so as to provide the cameras with an electrical power source.

Further limitations and disadvantages of conventional and traditional approaches will become apparent to one of skill in the art, through comparison of such approaches with some aspects of the present disclosure as set forth in the remainder of the present application with reference to the drawings.

### BRIEF SUMMARY OF THE DISCLOSURE

Shown in and/or described in connection with at least one of the figures, and set forth more completely in the claims, are battery belts suitable for mounting to a tree, post, pole, and/or other structure. A battery belt may include a control module, one or more battery modules, and a belt. The belt may include a belt strap and a belt buckle. The one or more battery modules may include one or more belt loops through which the belt strap of the belt may be threaded. After threading the belt strap through the one or more belt loops, the belt strap may be wrapped around a tree, post, pole, and/or other structure. The belt buckle may engage a free end of the belt strap to form a loop around the tree, post, pole, and/or other structure. The belt may then be tightened (i.e., a circumference of the formed loop may be reduced) to secure the battery belt to the tree, post, pole, and/or other structure. Moreover, the one or more belt loops may have a gripping surface. The gripping surfaces may engage surfaces of the tree, post, pole, and/or other structure and may aid in preventing the one or battery modules from sliding down the tree, post, pole, and/or other structure to which the battery belt is secured.

These and other advantages, aspects, and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1 depicts a block diagram of a battery belt secured to a tree in accordance with various aspects of the present disclosure.

FIG. 2 provides a perspective view of a battery system of the battery belt shown in FIG. 1.

FIG. 3 provides a block diagram of a belt used to secure the battery system of FIG. 2 to a tree or other structure.

FIGS. 4A and 4B depict aspects of a control module of the battery system shown in FIG. 2.

FIGS. 5A, 5B, 5C and 5D depict aspects of a battery module of the battery system shown in FIG. 2.

FIG. 6 depicts aspects of hinges that couple the control module and battery modules of FIG. 2 together in a daisy-chain fashion.

FIG. 7 provides a block diagram of example electrical components suitable for implementing the battery system shown in FIG. 2.

### DESCRIPTION

The present disclosure is directed to battery belts suitable for mounting to a tree, post, pole, and/or other structure. A battery belt may include a control module, one or more battery modules, and a belt. The belt may include a belt strap and a belt buckle. The one or more battery modules may include one or more belt loops through which the belt strap of the belt may be threaded. After threading the belt strap through the one or more belt loops, the belt strap may be wrapped around a tree, post, pole, and/or other structure. The belt buckle may engage a free end of the belt strap to form a loop around the tree, post, pole, and/or other structure. The belt may then be tightened (i.e., a circumference of the formed loop may be reduced) to secure the battery belt to the tree, post, pole, and/or other structure. Moreover, the one or more belt loops may have a gripping surface. The gripping surfaces may engage surfaces of the tree, post, pole, and/or other structure and may aid in preventing the one or battery modules from sliding down the tree, post, pole, and/or other structure to which the battery belt is secured.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

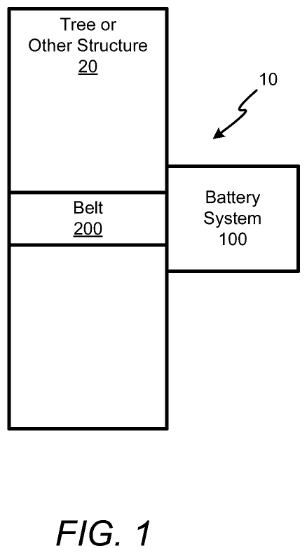

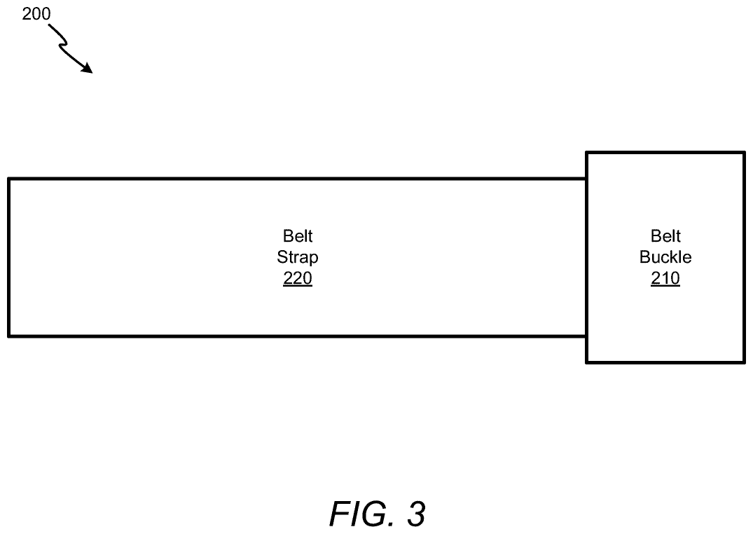

FIGS. 1-3 depict a battery belt 10 comprising a battery system 100 and a belt 200 in accordance with various aspects of the present disclosure. In general, the battery system 100 of the battery belt 10 may include a control module 110 and one or more battery modules 120 that cooperate to provide electrical power. Further, the belt 200 of the battery belt 10 may secure the battery system 100 to a tree or other structure 20 as shown in FIG. 1.

To this end, the belt 200 may include a flexible band or belt strap 210 and a belt clasp or buckle 220. The belt buckle 220 or portions thereof may be secured to one or both ends of the belt strap 210. In some embodiments, the belt buckle 220 may secure one end of the belt strap 210 to another part of the belt strap 210 (e.g., at or near an end opposite the belt buckle 220) so as to form a closed loop. The belt buckle 220 may take many suitable forms. However, per aspects of the present disclosure, the belt buckle 220 may permit buckling and unbuckling of the belt 200 so as to transition between an open loop configuration and a closed loop configuration. When unbuckled, the belt strap 210 may be wrapped around a tree or other structure 20 and then buckled to form a closed loop around the tree or other structure 20. The belt buckle 220 may further permit adjusting the circumference or length of the closed loop so as to permit tightening the belt 200 about an outer surface of the tree or other structure 20. The belt buckle 220 may further permit loosening and/or unbuckling of the belt 200 so as to permit unmounting and/or removal of the battery system 100 from the tree or other structure 20.

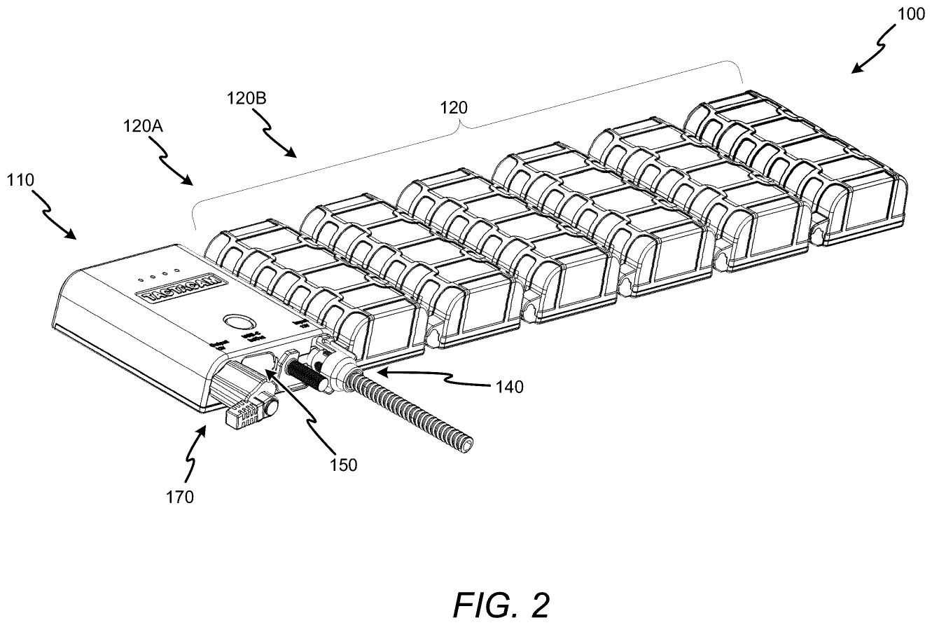

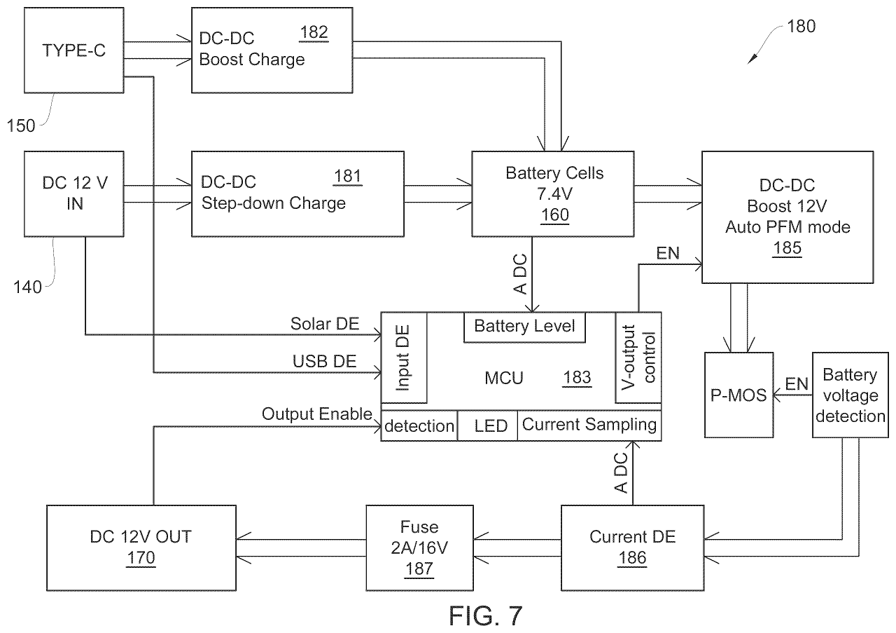

As shown in FIGS. 2-6, the battery system 100 may include a control module 110 and one or more battery modules 120. The control module 110 may include a control module housing 114 having a control module housing front side, a control module housing back side, a control module housing bottom sidewall, a control module housing top sidewall, a control module housing left sidewall, and a control module housing right sidewall. The control module housing sidewalls may generally circumscribe the control module housing front side and the control module housing back side. As such, the control module housing sidewalls, the control module housing front side, and the control module housing back side may general enclose or house one or more of electrical components of the control module 110. See, e.g., electrical components of FIG. 7.

Similarly, each battery module 120 may include a battery module housing 124 having a battery module housing front side, a battery module housing back side, a battery module housing bottom sidewall, a battery module housing top sidewall, a battery module housing left sidewall, and a battery module housing right sidewall. The battery module housing sidewalls may generally circumscribe the battery module housing front side and the battery module housing back side. As such, the battery module housing sidewalls, the battery module housing front side, and the battery module housing back side of each respective battery module housing 124 may generally enclose or house one or more battery cells 160 and supporting electrical components for a respective battery module 120.

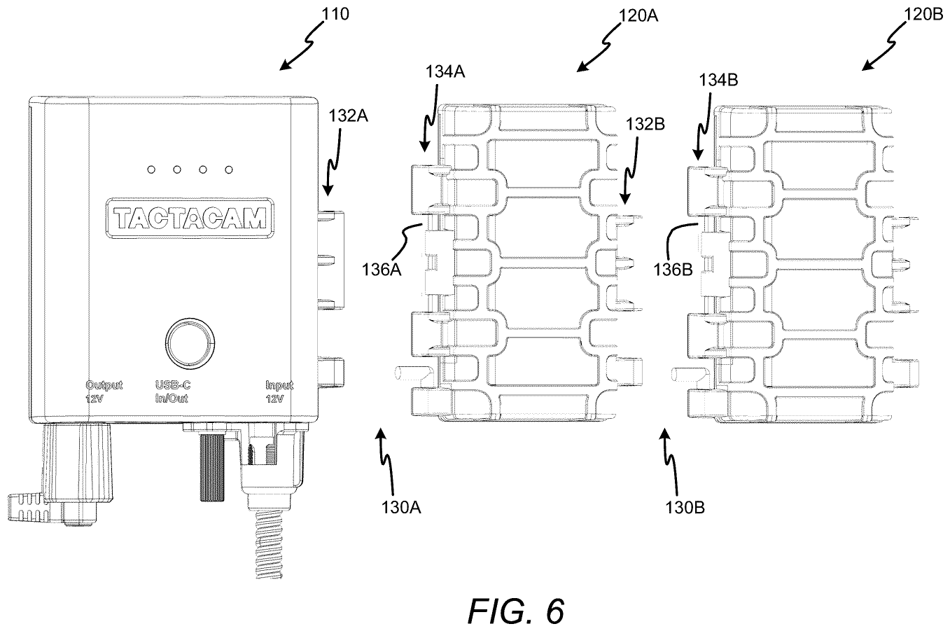

As shown in FIGS. 2 and 6, the control module 110 may be coupled to a first battery module 120A via a first hinge 130A. The first hinge 130A may provide a single axis of rotation between the control module 110 and the first battery module 120A. In various embodiments, the first hinge 130A may provide a rotation of about 90°about a single rotational axis. However, the first hinge 130A in other embodiments may permit a greater or lesser rotation about the single rotational axis.

As shown, the first hinge 130A may run along the control module housing right sidewall of the control module 110 and may run along the battery module housing left sidewall of the first battery module 120A. In particular, the control module housing right sidewall may include one or more hinge barrels 132A of the first hinge 130A. Conversely, the battery module housing left sidewall of the first battery module 120A may include one or more hinge barrels 134A of the first hinge 130A. The hinge barrels 134A of the first battery module 120A may mate and/or interleave with the one or more hinge barrels 132A of the control module 110. One or more pins 136A of the first hinge 130A may pass through the hinge barrels 132A, 134A so as to provide the first hinge 130A with a single rotational axis. Such configuration may orient the first hinge 130A such that the single rotational axis extends in general longitudinal alignment with or generally parallel to an outer surface of a tree or other structure 20 to which the battery system 100 is attached. Moreover, such orientation of the single rotational axis may also permit angling the control module 110 with respect to the first battery module 120A such that the control module housing back side of the control module 110 and the battery module housing back side of the first battery module 120A generally conform to an outer surface of the tree or other structure 20.

As further shown in FIGS. 2 and 6, the first battery module 120A may be coupled to a second battery module 120B via a second hinge 130B. The second hinge 130B may run along the battery module housing right sidewall of the first battery module 120A and may run along the battery module housing left sidewall of the second battery module 120B. In particular, the battery module housing right sidewall may include one or more hinge barrels 132B of the second hinge 130B. Conversely, the battery module housing left sidewall of the second battery module 120B may include one or more hinge barrels 134B of the second hinge 130B. The hinge barrels 134B of the second battery module 120B may mate and/or interleave with the one or more hinge barrels 132B of the first battery module 120A. One or more pins 136B of the second hinge 130B may pass through the hinge barrels 132B, 134B so as to provide the second hinge 130B with a single rotational axis. Such configuration may orient the second hinge 130B such that the single rotational axis extends in general longitudinal alignment with or generally parallel to an outer surface of a tree or other structure 20 to which the battery system 100 is attached. Such orientation of the single rotational axis may also permit angling the first battery module 120A with respect to the second battery module 120B such that the battery module housing back side of the first battery module 120A and the battery module housing back side of the second battery module 120B generally conform to an outer surface of the tree or other structure 20. In this manner, hinges such as hinge 130A, 130B may physically and electrically couple each battery module 120 and their respective battery cells 160 to the control module 110 in a daisy-chain manner.

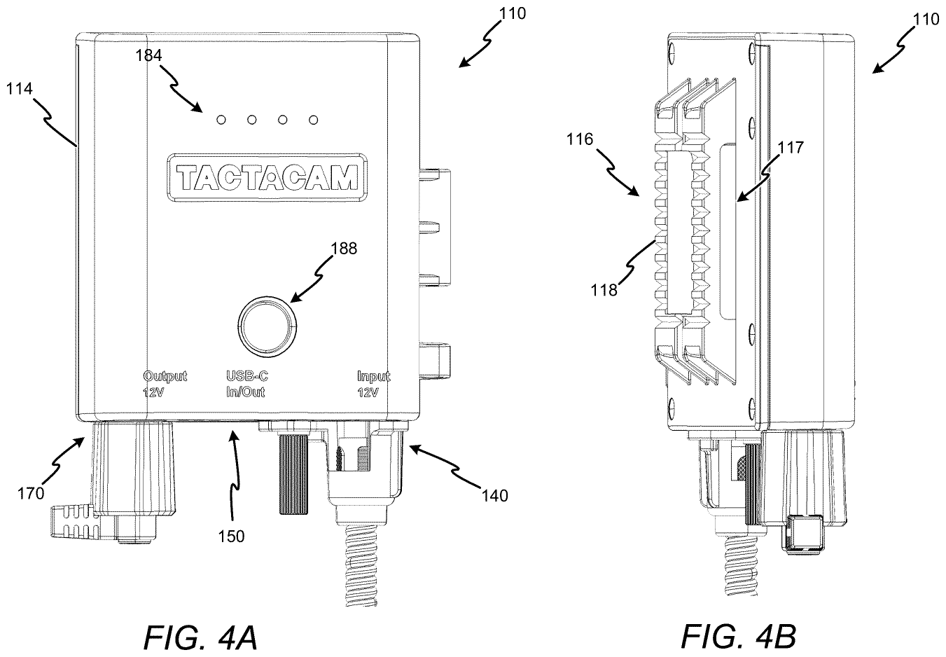

As shown in FIG. 4B, the control module 110 may include one or more belt loops 116 that protrude from the control module housing back side. Each belt loop 116 may provide an elongated belt loop opening or slot 117 sized to accommodate threading of the belt strap 210 therethrough. To this end, each belt loop opening 117 may have a vertical height that is greater than a width of the belt strap 210 and a lateral width that is greater than a thickness of the belt strap 210 so as to permit threading of the belt strap 210 through the belt loops 116.

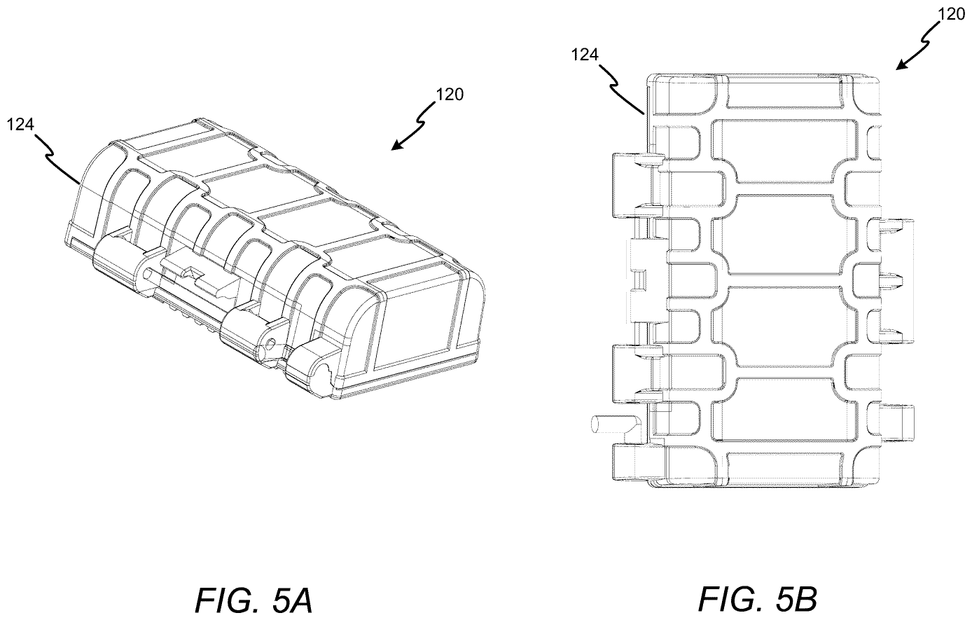

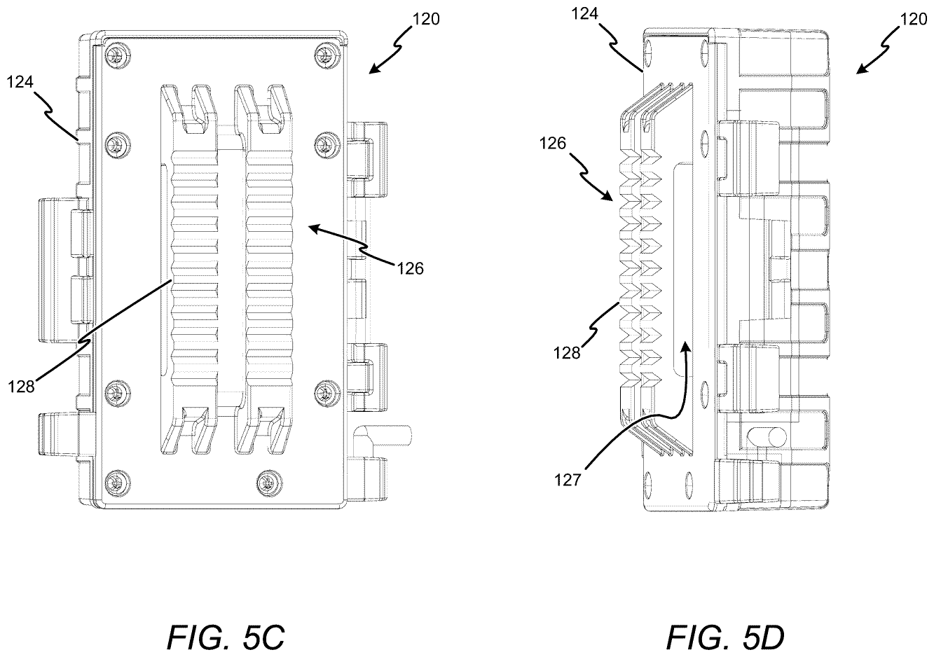

Similarly, as shown in FIGS. 5C and 5D, each battery module 120 may include one or more belt loops 126 that protrude from its respective battery module housing back side. Each belt loop 126 may provide an elongated belt loop opening or slot 127 sized to accommodate threading of the belt strap 210 therethrough. To this end, each belt loop opening 127 may have a vertical height that is greater than a width of the belt strap 210 and a lateral width that is greater than a thickness of the belt strap 210 so as to permit threading of the belt strap 210 through the belt loops 126.

The belt loops 116, 126 may be aligned vertically along the respective housing back sides and evenly distributed among the control module 110 and battery modules 120. Such an arrangement may aid in threading the belt strap 210 through the belt loops 116, 126 and may help retain the battery system 100 in a desired orientation when the belt 200 secures the battery system 100 to a tree or other structure 20.

As shown in FIGS. 4B, 5C, and 5D, one or more belt loops 116, 126 may have a gripping surface 118, 128 along one or more surfaces of the belt loops 116, 126. Such gripping surfaces 118, 128 may be positioned to engage the tree or other structure 20 to which the battery system 100 is secured. In particular, the gripping surfaces 118, 128 may comprise serrations, textures, protrusions, and/or other structures that effectively increase the friction between a back side of the battery system 100 and outer surfaces of the tree or other structure 20 to which the battery system 100 is secured. Such increased frictional and/or physical engagement may aid in maintaining the control module 110 and/or battery modules 120 at a desired position and may help prevent the battery system 100 from sliding down the tree or other structure 20 once the battery system 100 is secured to the tree or other structure 20 via belt 200.

Referring now to FIG. 7, a functional block diagram of example electrical components for the battery system 100 is shown. In particular, the control module 110 of the battery system 100 may include a first charging port 140, a second charging port 150, one or more output ports 170, and control circuitry, software, and/or firmware, hereafter control circuitry 180 that are coupled to one or more battery cells 160 of the one or more battery modules 120. The first charging port 140, the second charging port 150, and control circuitry 180 may cooperate to charge the one or more battery cells 160 based on electrical power received via either the first charging port 140 or the second charging port 150. The control circuitry 180 may also direct electrical power from the one or more battery cells 160 to the one or more output ports 170. In various embodiments, the battery system 100 may provide the output ports 170 with a total working output voltage of 12 volts and a maximum output current of 2 amps.

The first charging port 140 may be coupled to the one or more battery cells 160 via charging circuitry 181. In various embodiments, the first charging port 140 may comprise a solar panel electrical input port, but other embodiments may utilize a different port type. The charging circuitry 181 may include a, n efficient DC-DC step-down converter configured to step down a higher voltage (e.g., 12 volts) received via the first charging port 140 to a lower voltage level (e.g., 7 volts) suitable for charging the one or more battery cells 160. To this end, the charging circuitry 181 may include high-efficiency dedicated solar charging chips that are equipped with NTC battery temperature detection and maximum power point tracking (MPPT).

Similarly, the second charging port 150 may be coupled to the one or more battery cells 160 via charging circuitry 182. In various embodiments, the second charging port 150 may comprise a USB port (e.g., a USB-C port), but other embodiments may utilize a different port type. The charging circuitry 182 may include an efficient and high-precision two-stage charging management chip, which has three charging modes: trickle current, constant current, and constant voltage. The charging circuitry 182 may also include overvoltage and undervoltage protection as well as external NTC battery temperature protection for the one or more battery cells 160. In various embodiments, the second charging port 150 and charging circuitry 182 may cooperated to provide a maximum charging current of 2.5 A. Moreover, in some embodiments, the USB port or other port of the second charging port 150 may be an input/output port that supports both charging of the battery cells 160 and/or delivering electrical power of from the battery cells 160 to a device coupled to the respective port.

The control circuitry 180 may include a micro-controller 183 that monitors and generally controls the battery system 100. In particular, an analog-to-digital converter (ADC) input of the micro-controller 183 may be coupled to the one or more battery cells 160 so as to monitor an analog power level of the one or more battery cells 160. Based on the detected level, the micro-controller 183 may selectively light one or more light emitting diodes (LED) indicators in response to activation of a battery level indicator button 188.

For example, the control module 110 of the battery system 100 may comprise a four LED indicator 184. The micro-controller 183 of the control module 110 may illuminate one LED when the power level is between 0% and 25%, may illuminate two LEDs when the power level is between 25% and 50%, may illuminate three LEDs when the power level is between 50% and 75%, and may illuminate all four LEDS when the power level is between 75% and 100% of its fully charged level. Furthermore, the micro-controller 183 may detect the presence of power from the first charging port 140 and/or the second charging port 150 and enable/disable accordingly so as to charge the one or more battery cells 160 from a single source.

The control circuitry 180 may further include a high power and efficient synchronous boost converter 185 that boosts the power provided by the one or more battery cells 160 to levels suitable for the output ports 170. In various embodiments, the boost converter 185 may deliver an output efficiency up to 91% via an automatic light load pulse frequency modulation (PFM) mode. The boost converter 185 may be further equipped with 13.2V output overvoltage protection, may support cycle by cycle overcurrent protection, and may provide overheating protection.

The control circuitry 180 may further include current control circuitry 186 and a self recovery current limiting 2 A fuse 187. The current control circuitry 186 may be coupled to another analog-to-digital port of the micro-controller 183. In this manner, the micro-controller 183 may monitor a load current in real-time and control the load output based on the monitored current.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. A battery belt, comprising:
one or more battery modules, each battery module comprising a battery module housing comprising one or more battery belt loops and one or more battery cells in the battery module housing; and
a belt comprising a belt strap and a belt buckle; and
wherein each belt loop of the one or more belt loops is sized to permit threading of the belt strap therethrough.

2. The battery belt of claim 1, comprising:
a control module comprising a control module housing, at least one output port, and control circuitry within the control module housing; and
wherein the control circuitry is configured to deliver power from the one or more battery cells to the at least one output port.

3. The battery belt of claim 2, wherein:
the control module comprises at least one charging port; and
wherein the control circuitry is configured to charge the one or more battery cells based on electrical power received via the at least one charging port.

4. The battery belt of claim 3, wherein:
the at least one charging port comprises a solar panel electrical input port; and
the control circuitry is configured to charge the one or more battery cells based on electrical power received via the solar panel electrical input port.

5. The battery belt of claim 3, wherein:
the at least one charging port comprises a USB port; and
the control circuitry is configured to charge the one or more battery cells based on electrical power received via the USB port.

6. The battery belt of claim 1, wherein each belt loop has a length greater than a width of the belt strap and a width greater than a thickness of the belt strap so as to accommodate threading of the belt strap therethrough.

7. The battery belt of claim 1, wherein the belt loop of a first battery module of the one or more battery modules protrudes from the battery module housing for the first battery module.

8. The battery belt of claim 7, wherein the belt loop is textured to engage a surface of a structure to which the battery belt is mounted.

9. The battery belt of claim 7, wherein the belt loop is serrated to engage a surface of a structure to which the battery belt is mounted.

10. The battery belt of claim 2, wherein:
the control module housing is physically coupled to a first battery module via a first hinge; and
the control circuitry is electrically coupled to the one or more battery cells of the first battery module.

11. The battery belt of claim 10, wherein:
the control module housing comprises one or more hinge barrels of the first hinge; and
the battery module housing of the first battery module comprises one or more hinge barrels of the first hinge.

12. The battery belt of claim 10, wherein:
the first battery module is physically coupled to a second battery module of the one or more battery modules via a second hinge; and
the control circuitry is electrically coupled to the one or more battery cells of the second battery module via the first battery module.

13. The battery belt of claim 12, wherein:
the battery module housing of the first battery module comprises one or more hinge barrels of the second hinge; and
the battery module housing of the second battery module comprises one or more hinge barrels of the second hinge.

14. A battery module for use with a belt having a belt strap, the battery module comprising:
a battery module housing comprising one or more battery belt loops;
one or more battery cells in the battery module housing; and
wherein each belt loop of the one or more belt loops is provides an elongated slot sized to permit threading of the belt strap therethrough.

15. The battery module of claim 14, wherein the elongated slot of the each belt loop has a length greater than a width of the belt strap and a width greater than a thickness of the belt strap so as to accommodate threading of the belt strap therethrough.

16. The battery module of claim 14, wherein a first belt loop of the one or more belt loops comprises a gripping surface that protrudes from an outer surface of the battery module housing.

17. The battery module of claim 16, wherein the gripping surface of the first belt loop is textured to engage a surface of a structure to which the battery module is mounted.

18. The battery module of claim 16, wherein the gripping surface of the first belt loop is serrated to engage a surface of a structure to which the battery module is mounted.

19. The battery module of claim 16, wherein:
the battery module housing comprises one or more first hinge barrels along a first side of the battery module; and
the battery module housing comprises one or more second hinge barrels along a second side of the battery module.

20. The battery module of claim 16, wherein:
the battery module housing comprises one or more first hinge barrels along a first sidewall of the battery module housing; and
the battery module housing comprises one or more second hinge barrels along a second sidewall of the battery module housing that is opposite the first sidewall of the battery module housing.
